(19) United States
(12) Patent Application Publication
(10) Pub. No.: US 2025/0254723 A1
(43) Pub. Date: Aug. 7, 2025

(54) NETWORK IDENTIFICATION BASED REGIONAL CLEAR CHANNEL ASSESSMENT (CCA) SIGNALING WITH LISTEN BEFORE TALK (LBT) PROCEDURES

(71) Applicant: Apple Inc., Cupertino, CA (US)

(72) Inventors: Huaning Niu, San Jose, CA (US); Fangli Xu, Beijing (CN); Wei Zeng, Saratoga, CA (US); Oghenekome Oteri, San Diego, CA (US); Hong He, San Jose, CA (US); Chunxuan Ye, San Diego, CA (US); Yushu Zhang, Beijing (CN); Dawei Zhang, Saratoga, CA (US)

(21) Appl. No.: 18/857,542

(22) PCT Filed: Apr. 25, 2022
(86) PCT No.: PCT/CN2022/088899

§ 371 Date: Oct. 17, 2024

(51) Int. Cl. H04W 74/0808; H04W 74/00; H04W 84/04

(52) U.S. Cl. CPC H04W 74/0808; H04W 74/006; H04W 84/042

(57) ABSTRACT

Techniques discussed herein can facilitate listen before talk procedures for clear channel assessment (CCA) signaling. One example aspect is a baseband processor of a user equipment (UE), including one or more processors configured to receive a network identifier (ID); and determine, based on the network ID, a region for CCA procedures where the region is one of a first region or a second region. Subsequently, the one or more processors perform an initial LBT procedure based on the determined region; and generate an uplink (UL) message after performing the initial LBT procedure.

### FIELD

The present disclosure relates to wireless technology including New Radio (NR) listen before talk procedures and methods for regional clear channel assessment signaling.

### BACKGROUND

Mobile communication in the next generation wireless communication system, 5G, or new radio (NR) network will provide ubiquitous connectivity and access to information, as well as the ability to share data, around the globe. 5G networks and network slicing will be a unified, service-based framework that will target to meet versatile, and sometimes conflicting, performance criteria. 5G networks will provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)—Advanced technology with additional enhanced radio access technologies (RATs) to enable seamless and faster wireless connectivity solutions.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIG. 2 is a signal flow diagram outlining example signaling for regional clear channel assessment (CCA) signaling and listen initial before talk (LBT) procedures.

FIG. 3 is a signal flow diagram outlining example signaling for regional CCA signaling and LBT procedures for UL messaging.

FIG. 4 is a signal flow diagram outlining example signaling for regional CCA signaling and updated LBT procedures.

FIG. 5 is a signal flow diagram outlining example signaling for regional CCA signaling and LBT procedures after a UE initiates a maximum channel occupancy time (MCOT).

FIG. 6 illustrates a flow diagram of an example method for regional CCA signaling and initial access LBT procedure and fallback/non-fallback LBT procedures of a UE.

FIG. 7 illustrates a flow diagram of an example method for regional CCA signaling and LBT procedures of a UE that are updated or performed according to a MCOT.

FIG. 8 illustrates a flow diagram of an example method for CCA signaling corresponding to LBT procedures according to a base station (BS).

FIG. 9 illustrates an example of an infrastructure equipment, in accordance with various aspects disclosed.

FIG. 10 illustrates an example of a UE or base station BS platform, in accordance with various aspects disclosed.

### DETAILED DESCRIPTION

5G or NR networks may use a clear channel assessment (CCA) procedure before using a channel, for example, to determine if a channel is in use or clear for use. CCA procedures for the 60 GHz band (e.g. 57 GHz to 71 GHZ) can be used in conjunction with License Assisted Access (LAA) technologies for unlicensed bands such that the unlicensed spectrum use can coexist with other Radio Access Technologies (RATs). In some aspects, CCA procedures can make use of listen before talk (LBT) configurations to determine if a channel is available for use.

The CCA procedure can be region specific, for example, European standards and can be regulated by European Telecommunications Standards Institute (ETSI) EN 302 567, which can predominantly include Type 1 LBT procedures. A region where LBT operations are regulated by European standards can be referred to as a first region. In another example, the CCA procedure is regulated by Japanese standards where LBT is mandatory to facilitate spectrum sharing. A region where LBT operations are mandatory can be referred to as a second region. In some embodiments, the first region is a region other than a region regulated by Japanese standards. CCA and LBT procedures for the 60 GHz band require signaling between the user equipment (UE) and network (NW) for effective channel access and use in different regions.

In the United States (US) the Federal Communications Commission (FCC) may regulate CCA procedures and may not mandate a LBT procedure before using a channel, thus making LBT procedures optional. As such, the LBT regions can be categorized into a first category where LBT procedures are optional, such as the US, and a second category where LBT procedures are not optional, rather mandatory, such as the first or second regions. In some aspects, the NW can indicate through a Base Station (BS) to the UE that the UE is operating in either the first category or the second category. If the BS indicates operations in the second category, the UE further needs to determine if the UE is operating in the first region or the second region.

Various aspects of the present disclosure are directed towards CCA signaling between the UE and the NW and can apply to the 60 GHz band or other bands. Mechanisms by which the UE can determine its region (e.g., the first or second region) from a network identifier and perform initial access with the NW according to the region are presented herein. Mechanisms to indicate LBT procedures via downlink control information (DCI) are discussed herein. Mechanisms by which the UE can update or upgrade the LBT behavior after initial access are also discussed herein. Mechanisms presented herein facilitate CCA procedures between the UE and the NW by addressing various signaling, channel access, and LBT aspects in an efficient manner.

In some aspects, the BS transmits a network identification (ID), and the UE determines the first region or the second region CCA procedures based on the network ID. The UE can perform initial access with the BS according to an initial LBT procedure associated with the region determined from the network ID. For example, the initial access can be a random access channel (RACH) procedure including a message 1 (Msg1) or message A (MsgA) transmission where the initial LBT procedure associated with the network ID is performed before the RACH procedure.

The LBT procedure can follow one or more of several types or categories including a Type 1 (e.g., category 3 (CAT3)) LBT, Type 2 (category 2 (CAT2)) LBT, Type 3 (category 1 (CAT1)) LBT, associated with the indicated first or second region. As such, the UE can perform one or more of the Type 1, Type 2, or Type 3 LBT procedure before transmitting the RACH Msg1 or MsgA.

In addition, the UE can receive a DCI in a physical downlink control channel (PDCCH) message comprising a DCI CCA indication for LBT procedures before transmitting UL messages. The DCI CCA indication can indicate an updated or upgraded LBT procedure for messaging that is different than the initial LBT procedure associated with initial access. As such, the DCI can indicate, through a fallback DCI or non-fallback DCI format, the update or upgrade procedure. In other aspects, the BS or UE can initiate LBT procedures during a channel occupancy time (COT) or a maximum channel occupancy time (MCOT). Thus the BS can designate LBT update procedures for the first or second region according to a COT configured in the DCI by the BS. In other aspects, the UE can initiate an MCOT and autonomously update the LBT procedure according to the first or second region during the MCOT.

Thus, CCA described herein facilitates spectrum sharing between licensed and unlicensed spectrums by employing various aspects of LBT.

Additional aspects and details of the disclosure are further described below with reference to figures.

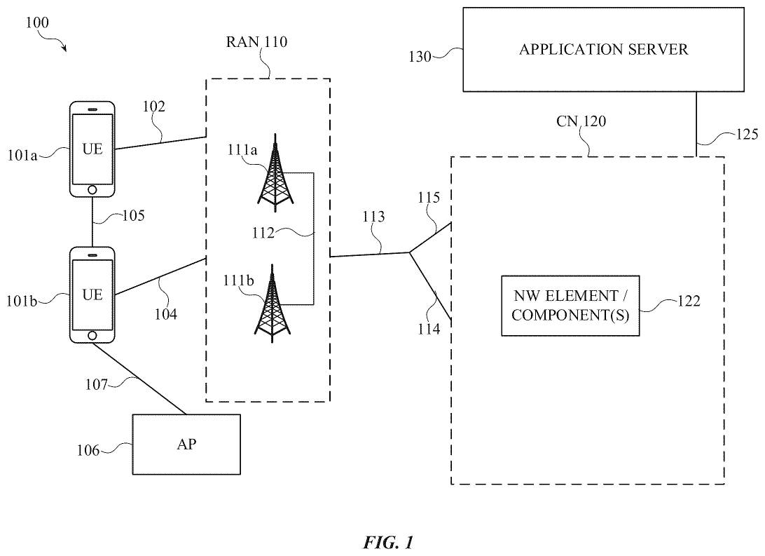

FIG. 1 illustrates example architecture of a wireless communication system 100 of a network that includes UE 101a and UE 101b (collectively referred to as “UEs 101” or “UE 101”), a radio access network (RAN) 110, and a core network (CN) 120. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system 100, and the term “E-UTRAN” or the like can refer to a RAN 110 that operates in an LTE or 4G system 100. The UEs 101 utilize connections (or channels) 102 and 104, respectively, each of which comprises a physical communication interface/layer. Channels 102 and 104 can facilitate one or more of licensed or unlicensed communication bands between the UE 101 and the RAN 110.

Accordingly, the UE 101 can receive the network ID by connections 102 or 104. Furthermore, the UE 101 can receive the DCI CCA indication in a PDCCH message by connections 102 or 104. The UE 101 can perform an initial LBT procedure according to the region indication before transmitting an initial access RACH message (e.g. RACH Msg1 or MsgA) over connections 102 or 104. The UE 101 can perform a LBT procedure according to the DCI CCA indication and subsequently transmit a UL message by connections 102 or 104.

Alternatively, or additionally, each of the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be connected via non-ideal backhaul, one providing NR access and the other one providing either E-UTRA for LTE or NR access for 5G, for example.

Alternatively, or additionally, each of the UEs 101 can be configured in a CA mode where multiple frequency bands are aggregated amongst component carriers (CCs) to increase the data throughput between the UEs 101 and the nodes 111a, 111b. For example, UE 101a can communicate with node 111a according to the CCs in CA mode. Furthermore, UE 101a can communicate with nodes 111a, 111b in a DC mode simultaneously and additionally communicate with each node of nodes 112 in the CA mode.

In this example, the connections 102 and 104 are illustrated as an air interface to enable communicative coupling. In aspects, the UEs 101 can directly exchange communication data via a ProSe interface 105. The ProSe interface 105 can alternatively be referred to as a sidelink (SL) interface 105 and can comprise one or more logical channels.

The RAN 110 can include one or more access nodes or RAN nodes 111a and 111b (collectively referred to as “RAN nodes 111” or “RAN node 111”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS), next generation base station (gNBs), RAN nodes, evolved next generation base station (eNBs), NodeBs, RSUs, Transmission Reception Points (TRxPs) or TRPs, and so forth.

In aspects where the system 100 is a 5G or NR system, the interface 112 can be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120.

The RAN 110 is shown to be communicatively coupled to a core network—in this aspect, CN 120. The CN 120 can comprise a plurality of network elements 122, which are configured to offer various data and telecommunication services to customers/subscribers (e.g., users of UEs 101) that are connected to the CN 120 via the RAN 110.

In some aspects, physical downlink shared channel (PDSCH) signaling may carry user data and higher layer signaling to UEs 101. The physical downlink control channel (PDCCH) may carry information about the transport format and resource allocations related to the PDSCH channel, among other things. The PDCCH may also inform UEs 101 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN 110 based on channel quality information fed back from any of UEs 101. The downlink resource assignment information may be sent on the PDCCH used for (e.g., assigned to) each of UEs 101.

The BS 111 can generate one or more of the network ID or DCI CCA indication. The BS 111 can subsequently transmit the network ID and the DCI CCA indication in a PDCCH message over connections 102 or 104. The BS 111 can receive the initial access message in a RACH message or the UL message after the UE 101 performs a corresponding LBT procedure according to connections 102 or 104. Furthermore, the BS 111 can generate CCA indications in RACH messaging, for example, a RACH message 2 (Msg2), and transmit the CCA indications to the UE 101 over connections 102 or 104.

### Network ID Based Regional CCA Signaling with LBT Procedures

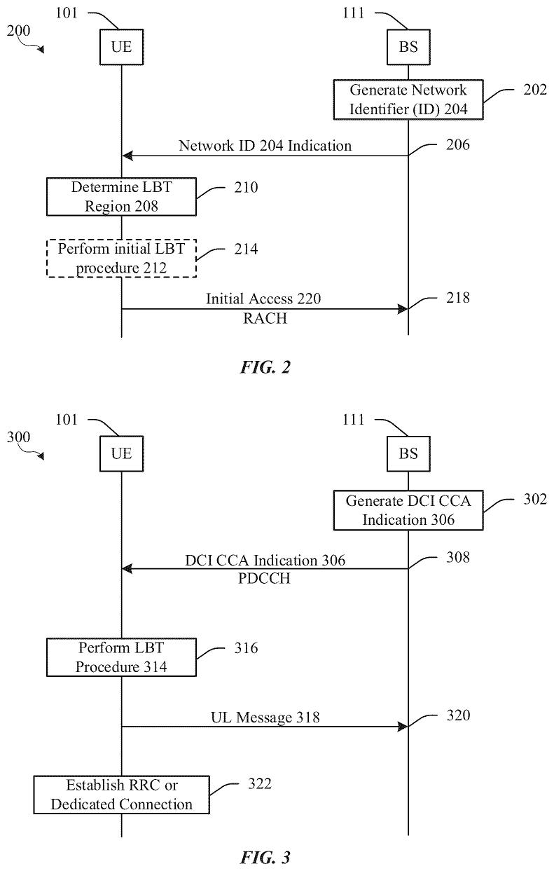

FIG. 2 is a signal flow diagram 200 outlining example signaling for regional clear channel assessment (CCA) signaling and initial listen before talk (LBT) procedures. In the signal flow diagram 200 a UE 101 receives a network ID a BS 111, determines a region (e.g., first region or second region) to perform CCA procedures including LBT procedures associated with the determined region to support unlicensed spectrum use. In some aspects, operations described in signal flow diagram 200 are for the 60 GHz band (e.g., 57 GHz to 71 GHZ) communications. CCA procedures are employed to determine channel use before conducting communications on a channel. LBT procedures can be employed with License Assisted Access (LAA) technologies to realize unlicensed spectrum use in the presence of other Radio Access Technologies (RATs). As different regions can be regulated by different requirements, signal flow diagram 200 describes signaling and procedures that apply to differing regions according to their specific regulations.

The BS 111 can coordinate with a NW (e.g. RAN 110, CN 120 of FIG. 1) to generate a network ID 204 at 202. The network ID 204 can correspond to one of a first region or a second region.

The first region can correspond to regions that predominantly utilize Type 1 (e.g., category 3 (CAT3)) LBT. In some aspects the first region is a region regulated by European standards. Additionally, or alternatively, the second region may be regulated by European Telecommunications Standards Institute (ETSI) EN 302 567. In some aspects, the second region utilize c1, c2, and or c3 bands and associated spectrum access requirements for the 60 GHz band (e.g. 57 GHz to 71 GHZ). The second region may require Type 1 LBT procedures according to the CCA operations defined ETSI EN 302 567. In other examples, aspects of the Type 1 LBT can include performing a CCA check in a channel where the device (e.g. UE 101 or BS 111) does not transmit if the channel is occupied, the device performs CCA using energy detection where transmissions are deferred when the channel is not occupied for a period of time, and where the device schedules transmissions in the channel according to a COT or MCOT when the channel is clear. In some aspects, the first region can further include Type 2 (category 2 (CAT2)) LBT or Type 3 (category 1 (CAT1))) LBT.

The second region can correspond to regions where LBT procedures are mandatory before every transmission. In some aspects, the LBT procedures mandatory for initial access 220 and/or unlicensed spectrum use generally. In some aspects, the second region can be a region regulated by Japanese standards. The LBT procedures for the second region can be dynamic and can include one or more of a Type 1 LBT or Type 2 LBT. The Type 1 LBT procedure can be the Type 1 LBT procedure described in association with the first region. The Type 2 LBT procedure can be a one-step procedure, or a one-shot procedure. The Type 2 LBT procedure can include channel sensing for a period of time, and if the channel is idle during the fixed period of time, the channel can be accessed. If the channel is not idle or clear, then the channel can be sensed again for the period of time at a determined interval. In some aspects, the Type 2 LBT procedure includes a channel check for a period of time (e.g., 5 μs), and if the channel is clear or not occupied during the channel check, then transmission can occur on the channel. As described further herein, the Type 2 LBT may be performed according to a capability of UE 101.

In the United States (US) the Federal Communications Commission (FCC) may regulate CCA procedures and may not mandate a LBT procedure before using a channel, thus making LBT procedures optional. The LBT regions can be categorized into a first category where LBT procedures are optional, such as the US, and a second category where LBT procedures are not optional, rather mandatory, such the first and second region. In some situations, the NW can indicate through the BS 111 to the UE 101 that the UE 101 is operating in either the first category or the second category, for example, by a 1 bit indicator in a system information block (e.g., SIB1). If the BS 111 indicates operations in the second category, the UE 101 further needs to determine if the UE 101 is operating in the first region or the second region. In this aspect, the UE 101 can determine the first or second region based on the network ID 204.

After generating the network ID 204, the BS 111 can transmit a network ID 204 indication at 206. At 210, the UE 101 can determine a LBT region 208 based on the network ID 204. The BS 111 can configure the network ID 204 based on a public or private network. For example, the BS 111 can generate the network ID 204 to identify a public land mobile network (PLMN) and the BS 111 can further configure a mobile country code (MCC) associated with the network ID 204. In this aspect, the UE 101 can determine the LBT region 208 based on the MCC comprised in or associated with the network ID 204. The MCC can consist of three digits, and the MCC can uniquely identify the country associated with the mobile subscription for the UE 101. Thus, the network ID 204 can include a PLMN-Identity information element that identifies the PLMN ID and the MCC. The BS 111 can configure the MCC with a country code identifying the first region, for example, a European country. The BS 111 can configure the MCC with a country code, for example, 440 or 441, identifying the second region, for example, Japan.

In other aspects, the BS 111 configures the network ID 204 based on a standalone non-public network (SNPN). In this aspect, the network ID 204 includes the PLMN ID and a network identifier (NID) that identifies the SNPN. The PLMN ID used for SNPNs do not have to be unique and can be based on a general MCC such as 999 that may not identify a country. In other aspects, the MCC associated with SNPN can be unique and used to identify the LBT region 208. When the MCC does not identify the LBT region 208 from the MCC or PLMN ID/NID, the UE 101 can determine the LBT region 208 based on UE 101 subscription data associated with the network ID 204.

In yet other aspects, the UE 101 determines the LBT region 208 at 210 based on pre-provisioned information. The UE 101 can processes pre-provisioned information and may or may not use the network ID 204 with the pre-provisioned information in determining the LBT region 208.

At 214 the UE 101 can perform an initial LBT procedure 212 according to the determined LBT region 208. The initial LBT procedure 212 is performed before the UE 101 transmits an initial access 220 message by, for example, a random access channel (RACH) attempt, such as a message 1 (Msg1) or message A (MsgA). The type of initial LBT procedure 212 performed at 214 is dependent on the determine LBT region 208 and can be a Type 1, Type 2, or Type 3 LBT procedure.

When the LBT region 208 is the first region, the UE 101 can directly transmit the initial access 220 transmission at 218 without performing the initial LBT procedure 212 at 214. In some aspects, the initial LBT procedure 212 is a Type 3 (category 1 (CAT1)) LBT procedure where a channel is accessed immediately without performing LBT. In other aspects, Type 3 LBT corresponds to accessing a channel immediately if the channel is accessed during a channel occupancy time (COT). The COT can be a transmit opportunity period (TXOP). While the first region may predominantly use Type 1 LBT procedures before messaging, the UE 101 can generate the RACH signal as a short control signaling. In some aspects, the short control signaling is as defined in ETSI EN 302 567 and applicable to the first region. In some aspects, the short control signaling are transmissions that occur without sensing the channel for the presence of other signals. The short control signaling can be limited with respect to an observation period (e.g. 100 ms) where short control signaling transmissions are less than 10 ms within an observance period. In some aspects, the UE 101 assumes that the BS 111 does not schedule other transmissions during a time period for the UE 101 to perform RACH Msg1 or MsgA transmissions.

When the LBT region 208 is the second region, the UE 101 can perform one or more of a Type 1 or Type 2 LBT procedure as the initial LBT procedure 212 before generating and transmitting the initial access 220 RACH Msg1 or MsgA. The Type 2 LBT procedure is performed according to UE 101 capability. UE 101 capability includes optional features that the UE 101 can determine to implement or not to implement (e.g., Type 2 LBT). In this aspect, the initial LBT procedure 212 is performed in accordance with second region regulation.

The signal flow diagram 200 describes mechanisms by which the UE 101 can determine the LBT region 208 (e.g. the first or second region), based on the network ID 204 subsequently determine an initial LBT procedure 212 based on the determined LBT region 208. Said mechanisms facilitate spectrum sharing between licensed and unlicensed spectrums by performing LBT according to regulation based on region.

FIG. 3 is a signal flow diagram 300 outlining example signaling for regional CCA signaling and LBT procedures for uplink (UL) messaging. The signal flow diagram 300 shows signaling that can occur in addition or combination to the signaling of signal flow diagram 200 in FIG. 2. In signal flow diagram 300, the UE 101 receives a DCI CCA indication 306 from the BS 111, and can perform the LBT procedure according to the DCI CCA indication 306 before transmitting UL message 318. Aspects described herein provide CCA procedures where the BS 111 or UE 101 can schedule LBT procedures for UL messaging.

At 302, the BS 111 can generate a DCI CCA indication 306. The DCI CCA indication 306 can be used by the UE 101 for LBT procedure 314 before transmitting UL message 318. The DCI CCA indication 306 can be generated depending on a communication scheme between the UE 101 and the BS 111. In some aspects, the communication scheme does not make use of a DCI CCA indication 306, in other aspects, the communication scheme uses the DCI CCA indication 306 to determine LBT procedures.

At 308 the BS 111 can transmit a DCI in a physical downlink control channel (PDCCH) message where the DCI includes the DCI CCA indication 306. After the UE 101 receives the DCI CCA indication 306, the UE 101 can perform a LBT procedure 314 at 316 based on the DCI CCA indication 306. In some aspects, the DCI CCA indication is comprised in a fallback DCI format or a non-fallback DCI format. DCI format 0_0 can be a fallback DCI format for uplink resource allocations for the physical uplink shared channel (PUSCH). DCI format 1_0 can be a fallback DCI format for downlink resource allocations for the PDSCH. The LBT procedure 314 can be associated with the fallback DCI and performed before UL message 318 can be a RACH message 3 (Msg3) or other UE 101 UL messaging.

In some aspects, a LBT procedure is performed, for example, by the BS 111, prior to the RACH message 2 (Msg2), RACH message 4 (Msg4), or RACH message B (MsgB) according to a DCI format 1_0. In this aspect, the BS 111 can perform LBT procedures analogous to LBT procedure 314 prior to generating and transmitting downlink (DL) messaging. In other aspects, the LBT procedure 314 is performed by UE 101 prior to a RACH Msg3. The DCI CCA indication 306 can be a 0 bit, 1 bit, or 2 bit indication. In some examples, the 1 bit indication is comprised in a DCI format 0_0. In some aspects LBT type is indication for the LBT procedure 314 by a random access response (RAR) message, like a RACH Msg2 from the BS 111. In this aspect, the DCI CCA indication 306 can be associated with the RAR message for the RACH Msg2 where the LBT mode indicated in the RAR message is analogous to the discussed DCI CCA indication 306 and is a 0 bit, 1 bit, or 2 bit RAR indication. As such, LBT procedure 314 at 316 can be performed according to a RAR indication rather than the DCI indication.

In some aspects, the DCI CCA indication 306 is indicated by CCA bits in the DCI. In other aspects, the DCI CCA indication 306 is indicated without additional CCA bits or without dedicated CCA bits in the DCI, but rather, is indicated by the UE 101 receiving the DCI. In some aspects, LBT procedure 314 associated with the DCI CCA indication 306 are pre-configured and the UE 101 performs the associated procedures after receiving the DCI at 308.

In some examples, in the first region, where the DCI CCA indication 306 is comprised in a fallback DCI the UE 101 can perform a Type 1 or Type 3 LBT procedure at 316 for LBT procedure 314. If the BS 111 indicates a Type 1 LBT for the LBT procedure 314, the BS 111 can schedule a gap before the UE 101 transmits the UL message 318 so that the UE 101 has time according to the gap to perform the Type 1 LBT procedure. In some examples, BS 111 configures a COT and the UE 101 skips performing the LBT procedure 314, or does not perform the LBT procedure 314, or performs the Type 3 LBT when the UE 101 can generate and transmit the UL message 318 within the COT. Otherwise the UE 101 performs the Type 1 LBT when the UL message 318 is generated and transmitted outside of the COT. In some aspect, the DCI CCA indication 306 is a 1 bit or 2 bit indicator corresponding to the Type 1 LBT or Type 3 LBT. In other aspects, the DCI includes 0 bits associated with the DCI CCA indication 306, and the UE 101 performs the Type 1 or Type 3 LBT according to the COT autonomously as described above.

In some examples, in the second region, where the DCI CCA indication 306 is comprised in a fallback DCI, the UE 101 can perform the Type 1 or Type 2 LBT procedure as the LBT procedure 314 before generating and transmitting UL message 318 at 320. The UE 101 performs the Type 1 or Type 2 LBT procedure based on the capability of the UE 101 (also described as “UE 101 capability” or “UE capability”). In some aspects, the BS 111 sends the UE 101 a UECapbilityInquiry message requesting UE capability information. The UE 101 can respond to the UECapabilityInquiry with a UECapabilityInformation message that indicates to the BS 111 the UE 101 capability for a Type 2 LBT procedure. Based on the UECapabilityInformation, the BS 111 can determine to generate the DCI CCA indication 306 to indicate the Type 1 or Type 2 LBT procedure in a 1 bit or 2 bit fallback DCI format. In other examples, the BS 111 indicates the Type 1 or Type 2 LBT procedure, and the UE 101 determines which type of LBT procedure to perform autonomously based on UE 101 capability without the UE capability indication to the BS 111. In yet other examples, the DCI includes 0 bits associated with the DCI CCA indication 306, and the UE 101 performs the Type 1 or Type 2 autonomously based on UE 101 capability.

In some examples, in the first region, where the DCI CCA indication 306 is comprised in a non-fallback DCI, the UE 101 can perform a Type 1, Type 2, or Type 3 LBT procedure at 316 for LBT procedure 314. The non-fallback DCI can, for example, be a DCI format 1_1, DCI format 0_1 or the like. In some aspects, the DCI CCA indication 306 comprised in the non-fallback DCI is indicated to UE 101 after the BS 111 and UE 101 establish an RRC connection and thus the BS 111 receives UE 101 capability information. The BS 111 can generate the DCI CCA indication 306 based on the UE 101 capability information. The BS 111 can configure the DCI CCA indication 306 as a 2 bit indicator in a non-fallback DCI to identify the Type 1, Type 2, or Type 3 LBT procedure.

In some examples, in the second region, where the DCI CCA indication 306 is comprised in a non-fallback DCI, the UE 101 can perform a Type 1 or Type 2 LBT procedure at 316 for LBT procedure 314. In some aspects, the DCI CCA indication 306 comprised in the non-fallback DCI is indicated to UE 101 after the BS 111 and UE 101 establish a radio resource control (RRC) connection and thus the BS 111 receives UE 101 capability information. The BS 111 can generate the DCI CCA indication 306 based on the UE 101 capability information. The BS 111 can configure the DCI CCA indication 306 as a 1 bit or 2 bit indicator in the non-fallback DCI to identify the Type 1 or Type 2 LBT procedure. Alternatively, 0 bits are configured to indicate the DCI CCA indication 306 in the non-fallback DCI. In this aspect the UE 101 performs the Type 1 or Type 2 LBT procedure autonomously based on UE capability before UL message 318 or subsequent messaging without dynamic signaling with the BS 111. As such, the LBT procedure 314 is performed with minimal signaling overhead.

In some aspects, the UE 101 establishes an RRC connection or other dedicated connection before performing LBT procedure 314 at 316. In other aspects, after the UE 101 transmits the UL message 318 at 320, the UE 101 can establish an RRC connection or other dedicated connection according to a dedicated configuration from the BS 111 at 322. After the UE 101 is in an RRC connected state or other dedicated connection, the UE 101 can change or upgrade the LBT procedure for subsequent UL messaging.

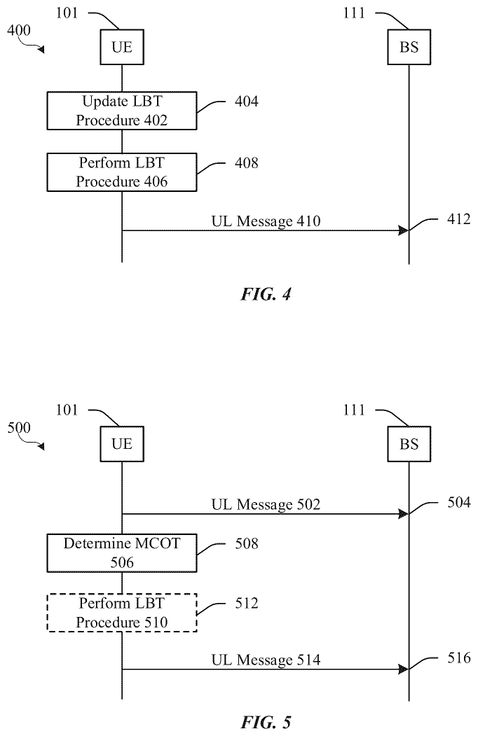

FIG. 4 is a signal flow diagram 400 outlining example signaling for regional CCA signaling and updated LBT procedures. Aspects of signal flow diagram 400 can occur after aspects of signal flow diagram 300 of FIG. 3, in other examples, aspects of signal flow diagram 400 can occur after signaling other than signal flow diagram 300. Aspects of signal flow diagram 400 can be performed in conjunction with one or more aspects of signal flow diagram 200 of FIG. 2 and signal flow diagram 300 of FIG. 3. Signal flow diagram 400 describes an update LBT procedure 402 performed by the UE 101 at 404 where the UE 101 can, for example, update or upgrade the LBT procedure 314 of FIG. 3 to a LBT that is different, specifically, LBT procedure 406 at 408. The LBT procedure 406 scheduled after update LBT procedure 402 can be referred to as a second LBT procedure. The update LBT procedure 402 can be associated with the DCI CCA indication 306 of FIG. 3 or based on a non-scheduling DCI format like a DCI format 2_0 according to a COT, or a DCI indication of a DCI that is different than the DCI associated with the DCI CCA indication 306. The update LBT procedure 402 can correspond to a LBT procedure according to a non-fallback DCI format. For example, the update LBT procedure 402 can correspond to a LBT procedure other than a format 0_0 or format 1_0, or according to a format 0_1, format 0_2, format 1_1, format 1_2, or the like. A DCI format 2_0 can indicate the update LBT procedure 402 according to a COT indicated by the BS 111. As such, the DCI format 2_0 can be a non-scheduling group DCI that is absent PDSCH or PUSCH scheduling information. Rather, the UE 101 determines if UL message 410 can be transmitted within a COT indicated by the format 2_0 and optionally upgrade the LBT procedure that may have been indicated by the DCI CCA indication 306 or other DCI. The following aspects describe update LBT procedure 402 before sending UL message 410 and after the UE 101 establishes a RRC or dedicated connection with BS 111, for example, at 322 of FIG. 3.

In the first region, the UE 101 can follow one or more RRC configured CCA bits in a non-fallback DCI to perform a Type 1 or Type 2 LBT procedure for the update LBT procedure 402. The UE 101 will configure update LBT procedure 402 when the UE 101 is configured by RRC for a LBT link with the BS 111. The RRC configuration can be cell specific or UE 101 specific.

In the first region, the UE 101 can be configured with a 1 bit or 2 bit CCA indicator in a DCI format, for example, the DCI CCA indication 306 of FIG. 3 or the like. For example, the LBT procedure 314 of FIG. 3, which can be referred to as a first LBT procedure, can be configured by the 1 bit or 2 bit DCI CCA indication 306 comprised in a non-fallback or fallback DCI. The first LBT procedure can be a Type 1 LBT procedure. The UE 101 can upgrade or update the Type 1 LBT procedure at 404 from the Type 1 LBT of the first LBT procedure to a Type 3 LBT procedure for the LBT procedure 406 at 408. In some aspects, the UE 101 can autonomously update or upgrade the LBT type to another LBT type if the UE 101 determines that the UL message 410 at 412 can be transmitted within a COT configured by the BS 111. The UE 101 can detect the COT in a detected DCI format 2_0. For example, the UE 101 can detect a COT from a DCI type format 2_0 and determine that the UE 101 can transmit the UL message 410 within the COT. Subsequently, the UE 101 can update the Type 1 LBT to a Type 3 LBT procedure, and generate the UL message 410 after performing the Type 3 LBT procedure within the COT. The Type 1 LBT procedure requires more time and resources to perform compared to the Type 3 LBT procedure, as such, by upgrading the Type 1 LBT procedure to the Type 3 LBT procedure, the UE 101 is able to transmit the UL message 410 at 412 sooner.

In the second region, the UE 101 can be configured with a 1 bit or 2 bit CCA indicator in a DCI format, for example, the DCI CCA indication 306 of FIG. 3 or the like. For example, the first LBT procedure can be configured by the 1 bit or 2 bit DCI CCA indication 306 comprised in a non-fallback or fallback DCI. The first LBT procedure can be a Type 1 LBT procedure. The UE 101 can upgrade or update the Type 1 LBT procedure at 404 from the Type 1 LBT of the first LBT procedure to a Type 2 LBT procedure for the LBT procedure 406 at 408. In some aspects, the UE 101 can autonomously update or upgrade the DCI indicated or RRC indicated LBT type to another LBT type if the UE 101 determines that the UL message 410 at 412 can be transmitted within a COT configured by the BS 111. The UE 101 can detect the COT in a detected DCI format 2_0. For example, the UE 101 can detect a COT from a DCI type format 2_0 and determine that the UE 101 can transmit the UL message 410 within the COT. Subsequently, the UE 101 can update the Type 1 LBT to a Type 2 LBT procedure, and generate the UL message 410 after performing the Type 2 LBT procedure within the COT.

In another example, for the second region, the BS 111 configured no bits in a DCI that indicates the update LBT procedure 402 at 404. In this example, the UE 101 autonomously performs the Type 2 LBT procedure for the LBT procedure 406 at 408. It is noted for the examples above, that the UE 101 performs the Type 2 LBT procedure based on UE 101 capability, where the UE 101 can indicate the UE 101 capability to the BS 111 and the BS 111 schedules the Type 2 LBT procedure accordingly. Alternatively, the UE 101 performs the Type 2 LBT autonomously according to UE 101 capability without BS 111 signaling. If the UE 101 is not capable of performing Type 2 LBT procedures, the UE 101 will perform the Type 1 LBT procedure at 408. The Type 1 LBT procedure can take longer to perform and use more resources compared to the Type 2 LBT procedure, as such, by upgrading to the Type 1 LBT procedure to the Type 2 LBT procedure, the UE 101 can transmit the UL message 410 at 412 sooner.

FIG. 5 is a signal flow diagram 500 outlining example signaling for regional CCA signaling and LBT procedures after a UE 101 initiates a maximum channel occupancy time (MCOT). Aspects of signal flow diagram 500 can occur after or in combination with aspects of signal flow diagram 200 of FIG. 2, signal flow diagram 300 of FIG. 3, signal flow diagram 400 of FIG. 4. Signal flow diagram 500 shows LBT procedures according to a MCOT 506 initiated by the UE 101 after prior UL messaging, for example, UL message 502 at 504. UL message 502 at 504 can be the UL message 410 of FIG. 4 or the UL message 318 of FIG. 3, or other UL messaging. In some aspects, the UL message 502 is referred to as a first UL message.

In the first region, the UE 101 can determine the MCOT 506 at 508, and can generate and transmit an indication of the MCOT. As such, the BS 111 can receive an indication of the MCOT. Subsequently, the UE 101 can resume UL messaging, for example, UL message 514 at 516 within the MCOT. The UE 101 can generate one or more UL messages, including UL message 514, without performing a LBT procedure associated with the one or more UL messages. Alternatively, the UE 101 can generate the UL message 514 during the MCOT after performing a Type 3 LBT procedure for the LBT procedure 510 at 512. The UE 101 can reduce signaling while realizing reliable UL messaging for unlicensed communications according to the UE 101 initiated MCOT. In this aspect, the BS 111 may not initiate signaling with the UE 101 during the MCOT, and the UE 101 may not initiate signaling other than UL message 514 during the MCOT. In some aspects, the LBT procedure 510 is referred to as a second LBT procedure. In some aspects, the UL message 514 is referred to as a second UL message.

In the second region, the UE 101 can determine the MCOT 506 at 508, and can generate and transmit an indication of the MCOT, for example, to the BS 111. Subsequently, the UE 101 can determine that no transmissions from the UE 101 or BS 111 occur during a gap period. For example, the UE 101 can determine that the UE 101 has not transmitted UL message 502 at 504 or other continuous transmissions during the gap period. Additionally, the UE 101 can determine that the BS 111 has not performed transmissions to the UE 101 during the gap period. The BS 111 can schedule no transmissions during the gap period based on the indication of the MCOT. The UE 101 can perform a Type 1 LBT or Type 2 LBT procedure for the LBT procedure 510 at 512 in response to determining that no transmissions occurred during the gap period (e.g., UE 101 UL messaging and BS 111 DL messaging). The UE 101 can autonomously perform the Type 1 or Type 2 LBT procedure based on UE 101 capability. The UE 101 can then generate one or more UL messages, like UL message 514 at 516, during the MCOT after performing the LBT procedure 510 at 512. As such, the UE 101 can autonomously perform a LBT procedure that minimizes signaling according to the UE 101 determined region after a RRC or dedicated connection is made with BS 111 based on the UE 101 initiated MCOT. Thus the minimized signaling is performed by UE 101 without signaling from BS 111.

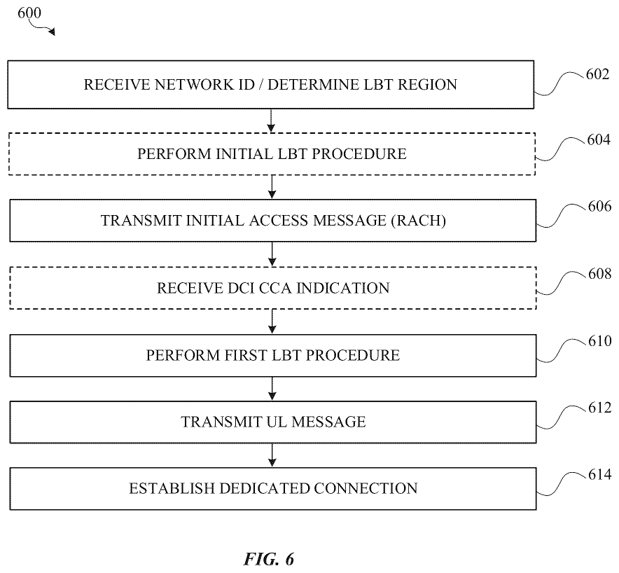

FIG. 6 illustrates a flow diagram of an example method 600 for regional CCA signaling and initial access LBT procedure and fallback/non-fallback LBT procedures of a UE. The example method 600 may be performed, for example by the UE 101 of FIGS. 1-5.

At 602, the method includes receiving a network ID and determining a LBT region based on the network ID. The network ID can indicate a public or private network wherein the LBT region is determined to be either a first region or a second region. The first region can primarily utilize Type 1 LBT operations and can be a region regulated by European standards. The second region can correspond to regions where LBT procedures are mandatory before UL transmissions and can be a region regulated by Japanese standards. FIG. 2 at 206 and 210 corresponds to some aspects of act 602.

At 604, the method includes optionally performing an initial LBT procedure according to the determined LBT region based on the network ID. In the first region, the LBT procedure can be a Type 1 LBT procedure where the channel is accessed immediately without performing LBT. As such, the initial LBT procedure may not be performed. In the second region, the initial LBT procedure is Type 1 or Type 2 LBT procedure based on UE capability. Thus the UE autonomously determines to perform the initial LBT procedure and autonomously determines what type of LBT procedure to perform. FIG. 2 at 214 corresponds to some aspects of act 604.

At 606, the method includes transmitting an initial access RACH message after performing the initial LBT procedure or skipping the initial LBT procedure. The initial access RACH message can be a RACH Msg1 or RACH MsgA. FIG. 2 at 218 corresponds to some aspects of act 606.

At 608, the method includes optionally receiving a DCI CCA indication. The DCI CCA indication can be comprised in a fallback DCI format or a non-fallback DCI format. The DCI CCA indication may be received before or after transmitting the initial access message at 606. FIG. 3 at 308 corresponds to some aspects of act 608.

At 610, the method includes performing a first LBT procedure. The first LBT procedure can be performed after the transmitting the initial access RACH message at 606. The first LBT procedure can be based on the DCI CCA indication, or can be autonomously be determined by the UE. In the first region, the LBT procedure can be a Type 1, Type 2, or Type 3 LBT procedure. In the second region, the LBT procedure can be a Type 1 or Type 2 LBT procedure based on the UE capability. FIG. 3 at 316 corresponds to some aspects of act 610.

At 612, the method includes transmitting a UL message after performing the LBT procedure at 610. The UL message can be a RACH Msg3. FIG. 3 at 320 corresponds to some aspects of act 612.

At 614, the method includes establishing a RRC connection or dedicated connection after transmitting one or more of the initial access RACH message at 606 or the UL message at 612. FIG. 3 at 322 corresponds to some aspects of act 614.

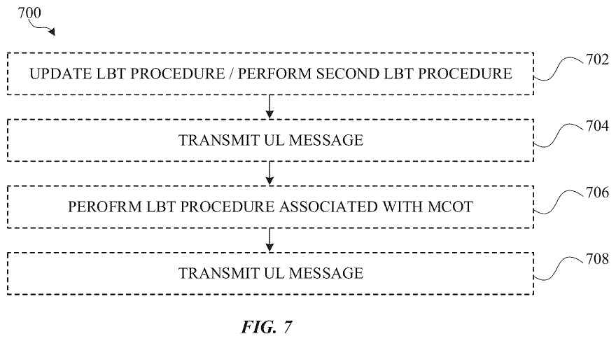

Some aspects of example method 600 can occur in a different order than presented, may be optional depending on signaling or determination scheme, and may be optional depending on the type of RACH procedure. Furthermore, example method 600 can be combined with other methods in partial or in full, for example, example method 700 of FIG. 7.

FIG. 7 illustrates a flow diagram of an example method 700 for regional CCA signaling and LBT procedures of a UE that are updated or performed according to a MCOT. The example method 700 may be performed, for example by the UE 101 of FIG. 1, 4, or 5.

At 702, the method optionally includes updating the LBT procedure relative to the first LBT procedure of first LBT procedure, for example, the first LBT procedure at 610 of FIG. 6. The update LBT procedure can be based on pre-configured instructions, CCA bits in a DCI, or autonomously by the UE. In the first region, a Type 1 LBT procedure can be updated to a Type 3 LBT procedure. In the second region, a Type 1 LBT procedure can be updated to a Type 2 LBT procedure based on UE capability. The method further includes optionally performing a second LBT procedure based on the update LBT procedure. In some aspects, the second LBT procedure can be performed after the initial LBT procedure at 605 or after the first LBT procedure at 610 of FIG. 6. FIG. 4 at 404 and 408 correspond to some aspects of act 702.

At 704, the method includes optionally transmitting a UL message after performing the second LBT procedure. The UL message can be associated with RRC signaling. FIG. 4 at 412 corresponds to some aspects of act 704.

At 706, the method includes optionally determining a MCOT and performing a LBT procedure associated with the MCOT. The MCOT can be initiated by the UE and can include indicating the MCOT to the BS. The LBT procedure associated with the MCOT can be performed in a different order, for example, before the UL message at 704. The LBT procedure associated with the MCOT can be performed after UL messaging, for example after UL messaging at 704, 612, or 606. FIG. 5 at 504, 508, and 512 correspond to some aspects of act 706.

At 708, the method includes transmitting a UL message within the MCOT after optionally performing the LBT procedure associated with the MCOT. FIG. 5 at 516 corresponds to some aspects of act 708.

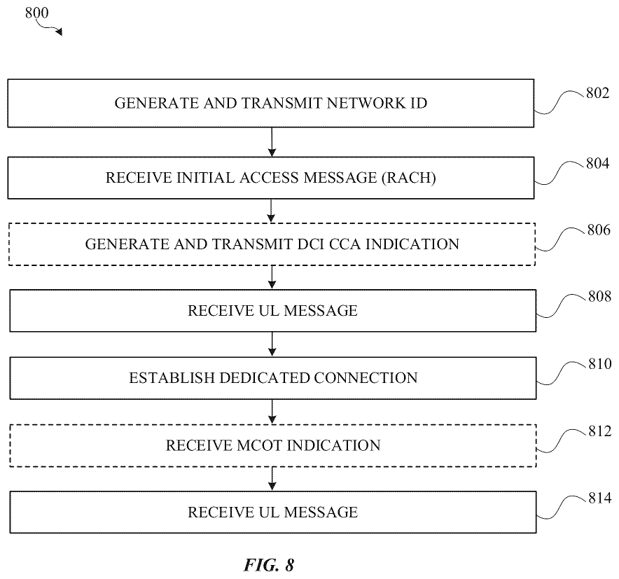

FIG. 8 illustrates a flow diagram of an example method 800 for CCA signaling corresponding to LBT procedures according to a BS. The example method 800 may be performed, for example by the BS 111 of FIGS. 1-6.

Some aspects of example method 700 can occur in a different order than presented, may be optional depending on signaling or determination scheme, and may be optional depending on the type of RACH procedure. Furthermore, example method 700 can be combined with other methods in partial or in full, for example, example method 600 of FIG. 6.

At 802, the method includes generating and transmitting a network ID. FIG. 2 at 202 and 206 correspond to some aspects of act 802.

At 804, the method includes receiving an initial access message, for example, an initial access RACH, in response to receiving the network ID. The initial access RACH can be a RACH Msg1 or MsgA. FIG. 2 at 218 corresponds to some aspects of act 804.

At 806, the method optionally includes generating and transmitting a DCI CCA indication that indicates a region specific LBT procedure. The DCI CCA indication can be comprised in a fallback or non-fallback DCI format and can indicate LBT procedures for a first or second region. In some aspects, the DCI CCA indication can be associated with a first LBT procedure or update LBT procedure. FIG. 3 at 302 and 308 correspond to some aspects of act 806.

At 808, the method includes receiving a UL message. The UL message can be received in response to transmitting the DCI CCA indication at 806. The UL message can be a RACH Msg3. FIG. 3 at 320 corresponds to some aspects of act 808.

At 810, the method includes establishing a RRC or dedicated connection with a UE after receiving one or more of the initial access RACH at 804 or the UL message at 808. FIG. 3 at 322 corresponds to some aspects of act 810.

At 812, the method optionally includes receiving a MCOT indication. FIG. 5 at 508 corresponds to some aspects of act 812.

At 814, the method optionally includes receiving a UL message. The UL message can be received during the MCOT indication of 812 or be associated with the update LBT procedure of 806, or be associated with the DCI CCA indication of 806. FIG. 3 at 320, FIG. 4 at 412, and FIG. 5 at 516 correspond to some aspects of act 814.

Some aspects of example method 800 can occur in a different order than presented, may be optional depending on signaling or determination scheme, and may be optional depending on the type of RACH procedure.

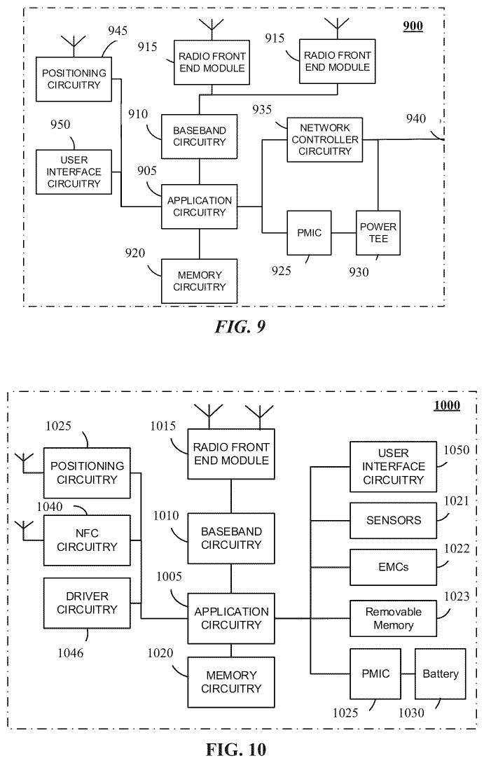

FIG. 9 illustrates an example of infrastructure equipment 900 in accordance with various aspects. The infrastructure equipment 900 (or “system 900”) may be implemented as a base station, radio head, RAN node such as the BS 111 of FIG. 1 and/or any other element/device discussed herein. In other examples, the system 900 could be implemented in or by a UE such as UE 101 of FIG. 1.

The system 900 includes application circuitry 905, baseband circuitry 910, one or more radio front end modules (RFEMs) 915, memory circuitry 920 (including a memory interface), power management integrated circuitry (PMIC) 925, power tee circuitry 930, network controller circuitry 935, network interface connector 940, satellite positioning circuitry 945, and user interface 950. In some aspects, the device of system 900 may include additional elements such as, for example, memory/storage, display, camera, sensor, or input/output (I/O) interface. In other aspects, the components described below may be included in more than one device. For example, said circuitries may be separately included in more than one device for CRAN, vBBU, or other like implementations.

The baseband circuitry 910 can be used to generate and transmit one or more of network ID 204 or DCI CCA indication 306, RRC configurations, dedicated configuration, or other signaling from the BS 111 described herein. Baseband circuitry 910 can be used to receive one or more of the initial access 220 RACH message, UL message 318, 410, 502, 514 or other signaling for the BS 111 described herein. Baseband circuitry 910 can be used to generate and transmit one or more of the initial access 220 RACH message, or UL message 318, 410, 502, 514 by the UE 101. Baseband circuitry 910 can be used to receive one or more of the network ID 204, DCI CCA indication 306, RRC configurations, dedicated configuration, or other signaling for the UE 101.

Application circuitry 905 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 905 may be coupled with or may include memory/storage elements and may be configured to execute instructions stored in the memory/storage to enable various applications or operating systems to run on the system 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

Application circuitry 905 can generate and or facilitate updating one or more of the initial LBT procedure 212 or LBT procedure 314, 406, 510 for the UE 101. Application circuitry 905 can generate the network ID 204, DCI CCA indication 306, RRC configuration, or dedicated configuration for the BS 111. Memory circuitry 920 can store one or more of the determined LBT region 208, initial LBT procedure 212, LBT procedure 314, 406, 510, DCI CCA indication 306, or the like for the UE 101.

The processor(s) of application circuitry 905 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some aspects, the application circuitry 905 may comprise, or may be, a special-purpose processor/controller to operate according to the various aspects herein. As examples, the processor(s) of application circuitry 905 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 900 may not utilize application circuitry 905, and instead may include a special-purpose processor/controller to process IP data received from an EPC or 5GC, for example.

User interface 950 may include one or more user interfaces designed to enable user interaction with the system 900 or peripheral component interfaces designed to enable peripheral component interaction with the system 900. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The components shown by FIG. 9 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 10 illustrates an example of a platform 1000 (or “device 1000”) in accordance with various aspects. In aspects, the platform 1000 may be suitable for use as the UE 101 of FIG. 1, and/or any other element/devices. The platform 1000 may include any combinations of the components shown in the example. The components of platform 1000 may be implemented as integrated circuits (ICs), portions thereof, discrete electronic devices, or other modules, logic, hardware, software, firmware, or a combination thereof adapted in the platform 1000, or as components otherwise incorporated within a chassis of a larger system. The block diagram of FIG. 10 is intended to show a high level view of components of the platform 1000. However, some of the components shown may be omitted, additional components may be present, and different arrangement of the components shown may occur in other implementations.

Application circuitry 1005 includes circuitry such as, but not limited to one or more processors (or processor cores), memory circuitry 1020 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 1005 may be coupled with or may include memory/storage elements and may be configured to execute instructions stored in the memory/storage to enable various applications or operating systems to run on the system 1000. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

Application circuitry 1005 can generate one or more of the initial LBT procedure 212 or LBT procedure 316, 408, 512 for the UE 101. Application circuitry 905 can generate the network ID 204, DCI CCA indication 306, RRC configuration, or dedicated configuration for the BS 111. Memory circuitry 1020 can store one or more of the initial LBT procedure 212, LBT procedure 316, 408, 512, network ID 204, DCI CCA indication 306, or the like for the UE 101.

As examples, the processor(s) of application circuitry 1005 may include a general or special purpose processor, such as an A-series processor (e.g., the A13 Bionic), available from Apple® Inc., Cupertino, CA or any other such processor. The processors of the application circuitry 1005 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 1005 may be a part of a system on a chip (SoC) in which the application circuitry 1005 and other components are formed into a single integrated circuit, or a single package.

The baseband circuitry or processor 1010 may be implemented, for example, as a solder-down substrate including one or more integrated circuits, a single packaged integrated circuit soldered to a main circuit board or a multi-chip module containing two or more integrated circuits. Furthermore, the baseband circuitry or processor 1010 may cause transmission of various resources.

The baseband circuitry 1010 can be used to generate and transmit one or more of the network ID 204 or DCI CCA indication 306, RRC configurations, dedicated configuration, or other signaling from the BS 111 described herein. Baseband circuitry 1010 can be used to receive one or more of the initial access 220 RACH message, UL message 318, 410, 502, 514, or other signaling for the BS 111 described herein. Baseband circuitry 1010 can be used to generate and transmit one or more of the initial access 220 RACH message or UL message 318, 410, 502, 514 by the UE 101. Baseband circuitry 1010 can be used to receive one or more of the network ID 204, DCI CCA indication 306, RRC configurations, dedicated configuration, or other signaling for the UE 101.

The platform 1000 may also include interface circuitry (not shown) that is used to connect external devices with the platform 1000. The interface circuitry may communicatively couple one interface to another. The external devices connected to the platform 1000 via the interface circuitry include sensor circuitry 1021 and electro-mechanical components (EMCs), as well as removable memory devices coupled to removable memory circuitry.

A battery 1030 may power the platform 1000, although in some examples the platform 1000 may be mounted deployed in a fixed location, and may have a power supply coupled to an electrical grid. The battery 1030 may be a lithium ion battery, a metal-air battery, such as a zinc-air battery, an aluminum-air battery, a lithium-air battery, and the like. In some implementations, such as in V2X applications, the battery 1030 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BS 111 of FIG. 1 can comprise a memory interface and processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a baseband processor of a user equipment (UE), comprising: one or more processors configured to: receive a network identifier (ID); determine, based on the network ID, a region for clear channel assessment (CCA) procedures where the region is one of a first region or a second region; perform an initial LBT procedure based on the determined region; and generate an uplink (UL) message after performing the initial LBT procedure.

Example 2 includes the baseband processor of example 1, wherein the initial LBT procedure are associated with at least some regulation in the first region, and wherein LBT is mandatory in the second region.

Example 3 includes the baseband processor of example 2, wherein the first region is regulated by European standards, and the second region is regulated by Japanese standards.

Example 4 includes the baseband processor of example 1, wherein the network ID identifies a public land mobile network (PLMN), and the region is determined based on a mobile country code (MCC) comprised in the network ID; and wherein the second region is determined when the MCC identifies a country code associated with Japan, otherwise the first region is determined.

Example 5 includes the baseband processor of example 1, wherein the network ID includes a public land mobile network (PLMN) ID and a network identifier (NID) that identifies a standalone non-public network (SNPN), and the region is determined based on a UE subscription data associated with the network ID.

Example 6 includes the baseband processor of example 1, wherein when the determined region is the first region, and the initial LBT procedure is a Type 3 LBT procedure.

Example 7 includes the baseband processor of example 1, wherein when the determined region is the second region, and the initial LBT procedure is one or more of a Type 1 LBT procedure or Type 2 LBT procedure.

Example 8 includes the baseband processor of example 7, wherein the Type 2 LBT procedure is performed based on a capability of the UE.

Example 9 is an apparatus of a user equipment (UE), comprising: one or more processors communicatively coupled to a memory device and the one or more processors configured to: receive a network identifier (ID); determine, based on the network ID, a region for clear channel assessment (CCA) procedures where the region is one of a first region associated with European LBT procedures or a second region associated with Japanese LBT procedures; receive a downlink control information (DCI) comprising a DCI CCA indication; perform an LBT procedure based on the determined region and in response to receiving the DCI; and generate an uplink (UL) message after performing the LBT procedure.

Example 10 includes the apparatus of example 9, wherein the determined region is the first region and the DCI CCA indication is a 1 bit CCA indicator comprised in a fallback DCI format of the DCI that indicates a Type 1 LBT procedure or Type 3 LBT procedure, and the one or more processors are further configured to: perform the LBT procedure wherein the LBT procedure is one of the Type 1 LBT procedure or Type 3 LBT procedure; and generate the UL message after performing the LBT procedure.

Example 11 includes the apparatus of example 9, wherein the determined region is the second region and the DCI CCA indication is a 1 bit CCA indicator comprised in a fallback DCI format of the DCI that indicates a Type 1 LBT procedure or Type 2 LBT procedure, and the one or more processors are further configured to: perform the LBT procedure wherein the LBT procedure is one of the Type 1 LBT procedure or Type 2 LBT procedure; and generate the UL message after performing the LBT procedure.

Example 12 includes the apparatus of example 9, wherein the determined region is the first region and the DCI CCA indication is a 2 bit CCA indicator comprised in a non-fallback DCI format of the DCI that indicates a Type 1, Type 2, or Type 3 LBT procedure, and the one or more processors are further configured to: perform the LBT procedure wherein the LBT procedure is one of the Type 1, Type 2, or Type 3 LBT procedure; and generate the UL message after performing the LBT procedure.

Example 13 includes the apparatus of example 9, wherein the determined region is the second region and the DCI CCA indication is a 2 bit CCA indicator comprised in a non-fallback DCI format of the DCI that indicates a Type 1 or Type 2 LBT procedure, and the one or more processors are further configured to: perform the LBT procedure wherein the LBT procedure is one of the Type 1 or Type 2 LBT procedure; and generate the UL message after performing the LBT procedure.

Example 14 includes the apparatus of example 9, wherein the determined region is the second region and 0 bits are associated with the DCI CCA indication are comprised in a non-fallback DCI format of the DCI, and the one or more processors are further configured to: perform the LBT procedure wherein the LBT procedure is one of a Type 1 or Type 2 LBT procedure based on a capability of the UE; and generate the UL message after performing the LBT procedure.

Example 15 includes the apparatus of example 9, wherein the determined region is the first region and the DCI CCA indication indicates a Type 1 LBT procedure, and the one or more processors are further configured to: detect a channel occupancy time (COT) from the DCI; determine that the UL message can be generated during the COT; perform the LBT procedure, wherein the LBT procedure is a Type 3 LBT procedure; and generate the UL message during the COT after performing the LBT procedure.

Example 16 includes the apparatus of example 9, wherein the determined region is the second region and the DCI CCA indication indicates a Type 1 LBT procedure, and the one or more processors are further configured to: detect a channel occupancy time (COT) from the DCI; perform the LBT procedure, wherein the LBT procedure is a Type 2 LBT procedure; and generate the UL message after performing the LBT procedure.

Example 17 is a baseband processor of a user equipment (UE), comprising: one or more processors configured to: receive a network identifier (ID); determine, based on the network ID, a region for clear channel assessment (CCA) procedures where the region is one of a first region or a second region; determine a maximum channel occupancy time (MCOT); and generate a uplink (UL) message during the MCOT.

Example 18 includes the baseband processor of example 17, wherein the determined region is the first region and the one or more processors are further configured to: generate the UL message during the MCOT without performing a LBT procedure associated with the UL message.

Example 19 includes the baseband processor of example 17, wherein the determined region is the second region and the one or more processors are further configured to: determine that no transmissions from the UE or a base station (BS) occur during a gap period; perform a LBT procedure where the LBT procedure is a Type 1 or Type 2 LBT procedure in response to determining that no transmissions occurred during the gap period; and generate the UL message during the MCOT after performing the LBT procedure.

Example 20 includes the baseband processor of any of examples 17-19, wherein the one or more processors are further configured to establish a radio resource control (RRC) connection before determining the MCOT.

A method as substantially described herein with reference to each or any combination substantially described herein, comprised in examples 1-20, and in the Detailed Description.

A non-transitory computer readable medium as substantially described herein with reference to each or any combination substantially described herein, comprised in examples 1-20, and in the Detailed Description.

A wireless device configured to perform any action or combination of actions as substantially described herein, comprised in examples 1-20, and in the Detailed Description.

An integrated circuit configured to perform any action or combination of actions as substantially described herein, comprised in examples 1-20, and in the Detailed Description.

An apparatus configured to perform any action or combination of actions as substantially described herein, comprised in examples 1-20, and in the Detailed Description.

A baseband processor configured to perform any action or combination of actions as substantially described herein, comprised in examples 1-20, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, comprising:
one or more processors configured to:
receive a network identifier (ID);
determine, based on the network ID, a region for clear channel assessment (CCA) procedures where the region is one of a first region or a second region;
perform an initial LBT procedure based on the determined region; and
generate, for transmission by a radio frequency (RF) circuitry, an uplink (UL) message after performing the initial LBT procedure.

2. The baseband processor of claim 1, wherein the initial LBT procedure is associated with at least some regulation in the first region, and wherein LBT is mandatory in the second region.

3. The baseband processor of claim 2, wherein the first region is regulated by European standards, and the second region is regulated by Japanese standards.

4. The baseband processor of claim 1, wherein the network ID identifies a public land mobile network (PLMN), and the region is determined based on a mobile country code (MCC) comprised in the network ID; and
wherein the second region is determined when the MCC identifies a country code associated with Japan, otherwise the first region is determined.

5. The baseband processor of claim 1, wherein the network ID includes a public land mobile network (PLMN) ID and a network identifier (NID) that identifies a standalone non-public network (SNPN), and the region is determined based on a UE subscription data associated with the network ID.

6. The baseband processor of claim 1, wherein when the determined region is the first region, and the initial LBT procedure is a Type 3 LBT procedure.

7. The baseband processor of claim 1, wherein when the determined region is the second region, and the initial LBT procedure is one or more of a Type 1 LBT procedure or Type 2 LBT procedure.

8. The baseband processor of claim 7, wherein the Type 2 LBT procedure is performed based on a capability of the UE.

9. A user equipment (UE), comprising:
one or more processors communicatively coupled to a memory device and the one or more processors configured to:
receive a network identifier (ID);
determine, based on the network ID, a region for clear channel assessment (CCA) procedures where the region is one of a first region associated with European LBT procedures or a second region associated with Japanese LBT procedures;
receive a downlink control information (DCI) comprising a DCI CCA indication;
perform an LBT procedure based on the determined region and in response to receiving the DCI; and
transmit, by a radio frequency (RF) circuitry, an uplink (UL) message after performing the LBT procedure.

10. The UE of claim 9, wherein the determined region is the first region and the DCI CCA indication is a 1 bit CCA indicator comprised in a fallback DCI format of the DCI that indicates a Type 1 LBT procedure or Type 3 LBT procedure, and the one or more processors are further configured to:
perform the LBT procedure wherein the LBT procedure is one of the Type 1 LBT procedure or Type 3 LBT procedure; and
transmit, by the RF circuitry, the UL message after performing the LBT procedure.

11. The UE of claim 9, wherein the determined region is the second region and the DCI CCA indication is a 1 bit CCA indicator comprised in a fallback DCI format of the DCI that indicates a Type 1 LBT procedure or Type 2 LBT procedure, and the one or more processors are further configured to:
perform the LBT procedure wherein the LBT procedure is one of the Type 1 LBT procedure or Type 2 LBT procedure; and
transmit, by the RF circuitry, the UL message after performing the LBT procedure.

12. The UE of claim 9, wherein the determined region is the first region and the DCI CCA indication is a 2 bit CCA indicator comprised in a non-fallback DCI format of the DCI that indicates a Type 1, Type 2, or Type 3 LBT procedure, and the one or more processors are further configured to:
perform the LBT procedure wherein the LBT procedure is one of the Type 1, Type 2, or Type 3 LBT procedure; and
transmit, by the RF circuitry, the UL message after performing the LBT procedure.

13. The UE of claim 9, wherein the determined region is the second region and the DCI CCA indication is a 2 bit CCA indicator comprised in a non-fallback DCI format of the DCI that indicates a Type 1 or Type 2 LBT procedure, and the one or more processors are further configured to:
perform the LBT procedure wherein the LBT procedure is one of the Type 1 or Type 2 LBT procedure; and
transmit, by the RF circuitry, the UL message after performing the LBT procedure.

14. The UE of claim 9, wherein the determined region is the second region and 0 bits are associated with the DCI CCA indication are comprised in a non-fallback DCI format of the DCI, and the one or more processors are further configured to:
perform the LBT procedure wherein the LBT procedure is one of a Type 1 or Type 2 LBT procedure based on a capability of the UE; and
transmit, by the RF circuitry, the UL message after performing the LBT procedure.

15. The UE of claim 9, wherein the determined region is the first region and the DCI CCA indication indicates a Type 1 LBT procedure, and the one or more processors are further configured to:
detect a channel occupancy time (COT) from the DCI;
determine that the UL message can be generated during the COT;
perform the LBT procedure, wherein the LBT procedure is a Type 3 LBT procedure; and
transmit, by the RF circuitry, the UL message during the COT after performing the LBT procedure.

16. The UE of claim 9, wherein the determined region is the second region and the DCI CCA indication indicates a Type 1 LBT procedure, and the one or more processors are further configured to:
detect a channel occupancy time (COT) from the DCI;
perform the LBT procedure, wherein the LBT procedure is a Type 2 LBT procedure; and
transmit, by the RF circuitry, the UL message after performing the LBT procedure.

17. A baseband processor of a user equipment (UE), comprising:
one or more processors configured to:
receive a network identifier (ID);
determine, based on the network ID, a region for clear channel assessment (CCA) procedures where the region is one of a first region or a second region;
determine a maximum channel occupancy time (MCOT); and
generate, for transmission by a radio frequency (RF) circuitry, an uplink (UL) message during the MCOT.

18. The baseband processor of claim 17, wherein the determined region is the first region and the one or more processors are further configured to:
generate the UL message during the MCOT without performing a LBT procedure associated with the UL message.

19. The baseband processor of claim 17, wherein the determined region is the second region and the one or more processors are further configured to:
determine that no transmissions from the UE or a base station (BS) occur during a gap period;
perform a LBT procedure where the LBT procedure is a Type 1 or Type 2 LBT procedure in response to determining that no transmissions occurred during the gap period; and
generate, for transmission by the RF circuitry, the UL message during the MCOT after performing the LBT procedure.

20. The baseband processor of any of claims 17-19, wherein the one or more processors are further configured to establish a radio resource control (RRC) connection before determining the MCOT.
